(19) United States
(12) Patent Application Publication
(10) Pub. No.: US 2018/0165846 A1
(43) Pub. Date: Jun. 14, 2018

(54) GRAPHING DEVICE WITH AUTOMATIC SLIDER PARAMETER

(71) Applicant: Texas Instruments Incorporated, Dallas, TX (US)

(72) Inventor: Michel Georges Stella, Dallas, TX (US)

(21) Appl. No.: 15/660,558

(22) Filed: Jul. 26, 2017

Related U.S. Application Data
(60) Provisional application No. 62/433,332, filed on Dec. 13, 2016.

(51) Int. Cl. G06T 11/20; G09B 5/02; G09B 19/02

(52) U.S. Cl. CPC G06T 11/206; G09B 5/02; G06F 3/04847; G06T 2200/24; G09B 19/025

(57) ABSTRACT

Described examples include a graphing device having a display. The graphing device also has a processor operable to present a graph of a function on the display and operable to generate a slider on the display in which at least one parameter of the slider is derived from a context element of the graph.

### CROSS-REFERENCE TO RELATED APPLICATIONS

This application claims the benefit under 35 U.S.C. § 119(e) to co-owned U.S. Provisional Patent Application Ser. No. 62/433,332, filed Dec. 13, 2016, which is hereby fully incorporated herein by reference.

### TECHNICAL FIELD

This disclosure relates generally to graphing devices.

### BACKGROUND

Graphing display devices, such as graphing calculators, provide the ability to easily graph complex mathematical functions. An input method allows for the input of a mathematical formula or formulas. After input, the device displays a graph of those formulas on a screen. Graphing calculators are particularly useful in educational environments.

It is sometimes difficult to determine the exact data points on a displayed graph. The exact results of a point on the graph can be very important in contexts such as engineering. Various display mechanisms can display selected points on a graph. However, there is a need for graphing devices that can display data points accurately and easily.

### SUMMARY

In accordance with an example, a graphing device includes a display. The graphing device also includes a processor operable to present a graph of a function on the display and operable to generate a slider on the display in which at least one parameter of the slider is derived from a context element of the graph.

### BRIEF DESCRIPTION OF THE DRAWINGS

FIG. 1 is a drawing of a graphing device.

FIG. 2 is a simplified block diagram of a graphing device.

FIG. 3 is an image of a screen for a graphing device.

FIG. 4 is an image of a screen of an example graphing device.

FIG. 5 is an image of a screen of another example graphing device.

FIG. 6 is an image of a screen of another example graphing device.

FIG. 7 is a flow diagram of an example method.

FIG. 8 is a flow diagram detailing an example operation of the method of FIG. 7.

FIG. 9 is a flow diagram detailing another example operation of the method of FIG. 7.

### DETAILED DESCRIPTION

Corresponding numerals and symbols in the different figures generally refer to corresponding parts unless otherwise indicated. The figures are not necessarily drawn to scale.

The term “coupled” may include connections made with intervening elements, and additional elements and various connections may exist between any elements that are “coupled.”

For illustrative purposes, examples are described herein regarding the TI-Nspire™ handheld graphing calculators and the TI-Nspire™ software available from Texas Instruments Incorporated. A graphing device can be a device with built-in graphing capability, such as a TI-Nspire™ graphing calculator, or can be a more general purpose device using graphing software, such as a tablet or computer running TI-Nspire™ software. The examples described hereinbelow that include the TI-Nspire™ calculator and TI-Nspire™ software are merely examples and the arrangements are not limited to the examples and illustrative devices.

A handheld calculator such as the TI-Nspire™ can generate and operate on one or more documents. In the TI-Nspire™ environment, a document may include one or multiple problems. Each problem may contain multiple pages. Further, each page may include multiple work areas and each work area may contain any of the TI-Nspire™ applications; for example, Calculator, Graph, Geometry, Lists & Spreadsheet, Data & Statistics, and Notes. Selection of an application icon in a menu adds that application to a document. The Graph application provides functionality for, among other things, graphing mathematical equations. The documents “Getting Started with the TI-Nspire™/TI-Nspire™ CAS Handheld,” Texas Instruments Incorporated 2006-2013 and “TI-Nspire™ CAS Reference Guide,” Texas Instruments Incorporated, 2006-2014 further explain the operation of TI Nspire™ devices.

The TI-Nspire™ software executes on a computer system and enables users to perform the same functions on a computer system as those on a TI-Nspire™ calculator. That is, the software emulates the calculator operation. Documents generated using the TI-Nspire™ software can be used on a TI-Nspire™ calculator and vice versa. The documents “TI-Nspire™ CX Student Guidebook,” Texas Instruments Incorporated, 2006-2017, and “TI-Nspire™ CX Teacher Guidebook,” Texas Instruments Incorporated, 2006-2017 describe the TI-Nspire™ software. The Internet webpage at https://education.ti.com/en/guidebook/search?active=guidebooks provides further documentation on the operation of TI-Nspire™ devices and software. This specification refers to these documents and the documents cited in the preceding paragraph collectively as the “Nspire™ Documentation” and hereby incorporates these documents herein by reference.

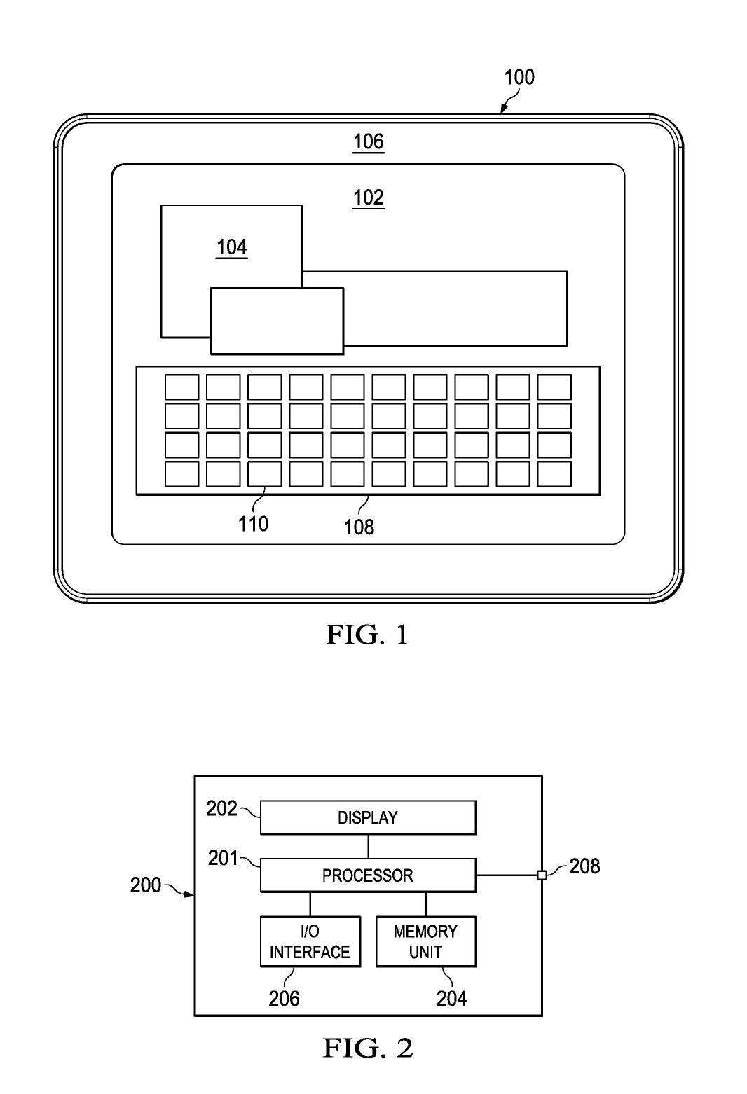

FIG. 1 shows a graphing device 100, for example a tablet computer, desktop computer or other device including a graphical display and computing functions. Graphing device 100 includes touch sensitive, graphical display 102. Graphical display 102 displays, for example, information input to applications executing on the graphing device 100 and outputs of the applications. Applications may use one or more windows 104 for displaying input and output information. Graphical display 102 may be, for example, a liquid crystal display (LCD). Some example graphing devices may include one or more control buttons (not shown), such as a power button, volume control buttons, etc. In addition, other examples include physical keyboards, numerical pads, direction keys and other keys for data entry and manipulation.

Graphing device 100 may not have a dedicated keyboard for data input. Instead, one or more applications may provide a virtual keyboard as illustrated by application window 108 that includes a set of keys 110. Display 102 includes touch detection circuitry that allows a user to interact with the display 102 by translating the motion and position of the user's fingers on the display 102 to provide functionality like using external input devices, such as a mouse and a keyboard. A user may use the touch sensitive display 102 to, for example, scroll the content of display 102, position a pointer, select screen elements, highlight screen elements, etc. Touch detection circuitry (not shown) detects touches to display 102. In some examples, the touch detection circuitry may be in a peripheral region 106 around the touch sensitive screen. In other examples, transparent circuitry in the face of the screen detects the presence and location of a finger or pointing instrument that is near or in contact with the surface of the screen, etc. Examples may use many types of currently known or later developed touch sensitive screens.

FIG. 2 is a simplified block diagram of a graphing device like graphing device 100 (FIG. 1). Graphing device 200 includes a processor 201 coupled to a memory unit 204, which may include one or more of read-only memory (ROM), erasable-programmable ROM (EPROM) and/or random-access memory (RAM). In some arrangements, the ROM and/or EPROM stores software programs implementing functionality described herein and the RAM stores intermediate data and operating results.

Touch sensitive display 202 includes control and interface circuitry and couples to processor 201 so that display 202 may provide touch location input data to processor 201. Processor 201 may be a microprocessor, a digital signal processor, a system on a chip (SOC), an application specific integrated circuit (ASIC) or other suitable processing element. In addition, processor 201 provides information for display on display 202. An input/output (I/O) port 208 may provide connectivity to external devices. I/O port 208 may be, for example, a bi-directional connection such as a universal serial bus (USB) port. Graphing device 200 also includes an I/O interface 206. The I/O interface 206 provides an interface to couple input devices such as power control and volume control buttons, for example, to processor 201. In some arrangements, I/O interface 206 and/or I/O port 208 may also include an integrated wireless interface or a port for connecting an external wireless interface. A single integrated circuit may include any of processor 201, memory unit 204, a wireless interface and/or I/O interface 206 and circuitry for driving I/O port 208. In addition, any or all of these components may be in different integrated circuits and interconnected in a hybrid module, a printed circuit board and/or in different interconnected housings.

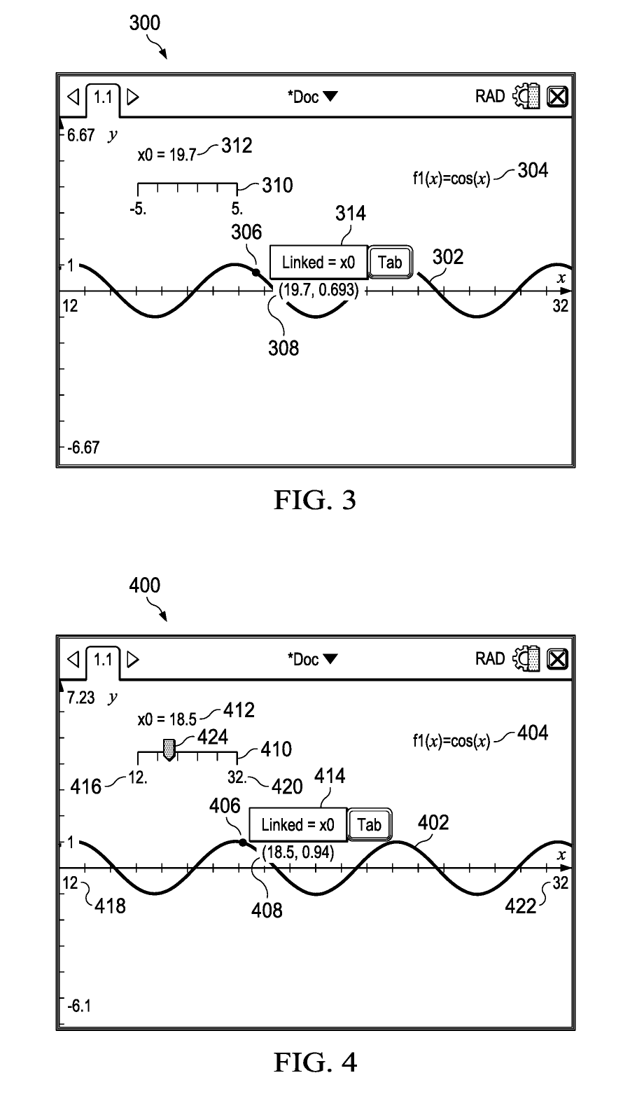

FIG. 3 is an image of a screen for a graphing device. An example graphing device is graphing calculator. In other examples, a tablet or computer running a graphing application may display an image 300. In this example, graph 302 is of Equation 1.

f1(x)=cos x (1)

Equation display 304 shows this equation. The form f1(x) indicates that this is the first displayed graph. FIG. 3 shows one graph. However, many devices can display several graphs simultaneously. Therefore, f1 is the label of this function to distinguish it from other graphed functions (not shown). The Nspire™ Documentation provides an example of a formula entry system suitable for entering Equation 1 and other equations.

A graph can show valuable information. However, it is often necessary to determine the exact value of a function at an exact point on the graph, such as point 306. At point 306, the point value display 308 shows that for x=19.7, f(x)=0.693. Entering point 306 to provide this output can be challenging. Tapping on a point with a touch sensitive display will give you the point value of a point, but it is very unlikely to be the exact point needed. The value of x may be entered directly. However, in the context of graphing, several points may be of interest and entering several points can be laborious.

One method for identifying a specific point is a slider like slider 310. A slider is a data entry device that ties to a variable. A slider includes a range of the variable, usually displayed linearly, and a pointer that moves (slides) along the range. The pointer selects a value for the variable. The user can select to display a slider like slider 310 from a menu or other feature selection mechanism. In the example of FIG. 3 the slider selects a value of a variable such as x0 as shown in display 312. In other examples, several sliders may select separate values of x (for example, x1, x2, etc.). The numbers in the value designators distinguish separate values. A touch device, directional keys or other input method allows the user to select a point on the slider by moving the pointer (not shown in FIG. 3). Display 314 indicates that point 306 connects to slider 310. As the slider moves, the value of x0 changes. However, the range of the slider limits the values of the slider. Slider 310 uses a default range for x0 that is −5 to 5. However, the range of graph 302 is from 12 to 32. Slider 310 cannot select any points in the range on the graph. Therefore, no pointer is displayed. The alternative is to manually enter the range for slider 310.

FIG. 4 is an image of a display of an example graphing device. Screen 400 shows a graph 402 of function 404. Point 406 on graph 402 has an x value of 18.5 in this example. In this example, display 414 obscures point 406. The display 414 indicates that the point 406 links to slider 410. An additional display 408 shows the (x, f(x)) coordinates of point 406.

A menu selection or other command generates slider 410. Rather than default values or manually entered values, in this arrangement slider 410 automatically takes a context element, such as the range, of graph 402. That is, upon creation of the slider, the minimum 416 of slider 410 takes the value of the minimum 418 of the range of graph 402. Also upon creation of slider 410, the maximum 420 of slider 410 takes the value of the maximum 422 of the range of graph 402. In this arrangement, the device insures that the pointer 424 of slider 410 can indicate the selected point on slider 410 and is not out of range. Moving pointer 424 along slider 410 selects a value of a variable such as x, which allows for displaying many (x, f(x)) coordinates very rapidly, thus facilitating analysis of function 404. Display 412 shows the currently selected value of slider 410.

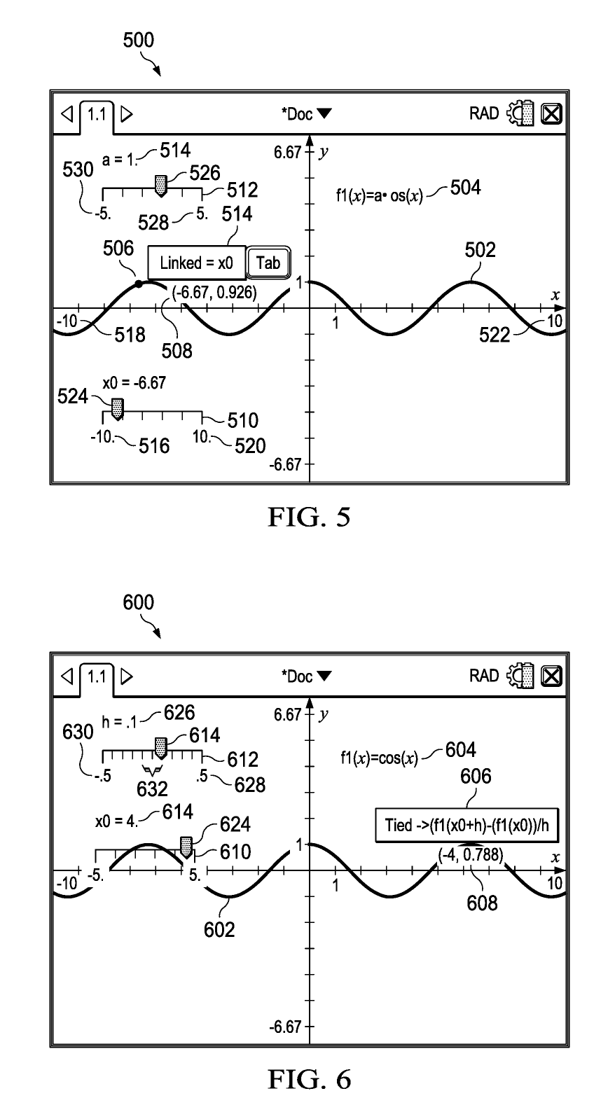

FIG. 5 is an image of a screen of an example arrangement for a graphing device. Screen 500 shows a graph 502 of function 504. Point 506 on graph 502 has an x value of −6.67 in this example. Display 514 indicates that the point 506 links to slider 510. An addition display 508 shows the (x, f(x)) coordinates of point 506. Function 504 contains an additional variable a. The variable a links to slider 512 as indicated by display 514.

A menu selection or other command generates sliders 510 and 512. Rather than default values or manually entered values, slider 510 automatically takes the range of graph 502. That is, upon creation of the slider, the minimum 516 of slider 510 takes the value of the minimum 518 of the range of graph 502. Also upon creation of slider 510, the maximum 520 of slider 510 takes the value of the maximum 522 of the rage of graph 502. This insures that the pointer 524 of slider 510 indicates the selected point on slider 510 and is not out of range. Moving pointer 524 along slider 510 allows for displaying many (x, f(x)) coordinates very rapidly.

In addition to slider 510, screen 500 includes slider 512. Slider 512 links to variable a in function 504. In an example arrangement, using a variable in function 504, such as variable a, automatically generates slider 512. Display 514 indicates that a is 1 in FIG. 5. Pointer 526 also indicates that a is 1. Because a is a variable in function 504, its relationship to the ranges of x or y (f(x)) may not be direct or even linear. Therefore, the maximum 528 and minimum 530 of slider 512 are set at default values or entered manually in a dialog box.

FIG. 6 is an image of a screen of an example graphing device. Screen 600 shows a graph 602 of function 604. Screen 600 includes slider 610. Display 614 indicates that the x0 links to value indicated by pointer 624 on slider 610. Display 606 shows that the equation displayed ties to function 604. In this example, the equation in display 606 is Equation 2:

$$\frac{f 1 ( x 0 + η ) - f 1 ( x 0 )}{η} \qquad ( 2 )$$

The letter “h” is a common substitute for the Greek letter η (“eta”), as shown in Equation 2, because the capital Eta (“H”) looks like the English letter H. The letter η commonly indicates an incremental value in regression analysis and in calculus. Slider 612 is generated when the user enters an equation, like Equation 2, that includes at least one other variable beside x. The user enters the equation using a dialog (not shown). Because Equation 2 includes η, slider 612 automatically creates small increments which are useful in regression and determining the slope of functions. Therefore, the variable η is a context element of the equation in graph 602 and slider 612 is configured in accordance with that context element. For example, in slider 612 the increments 632 are 0.1, which are in accordance with the function of η as an incremental value. Other variables may indicate a configuration of other parameters of slider 612. For example, co (small “omega”) often represents frequency or angular velocity in radians per second. This variable may be entered directly, if supported by the input device, or as a small “o.” A slider for this variable may have a range of 2π with increments being a fraction of π. In other examples, a slider may select logical features, such as maxima, minima or inflection points, rather than selecting a number.

The range of the slider 612 with a minimum 630 and maximum 628 is concomitant with increments 632. This configuration of slider 612 is selected because of the use of η in Equation 2. Display 608 shows the x0 value (in this case 4) and the result of equation 2 with the value of η selected by pointer 614 and shown in display 626, shown explicitly below in Equation 3.

$$\frac{f 1 ( x 0 + η ) - f 1 ( x 0 )}{η} = \frac{cos ( 4 + 0.1 ) - cos ( 4 )}{0.1} = \frac{- 0.5748 - ( - 0.6536 )}{0.1} = 0.788 \qquad ( 3 )$$

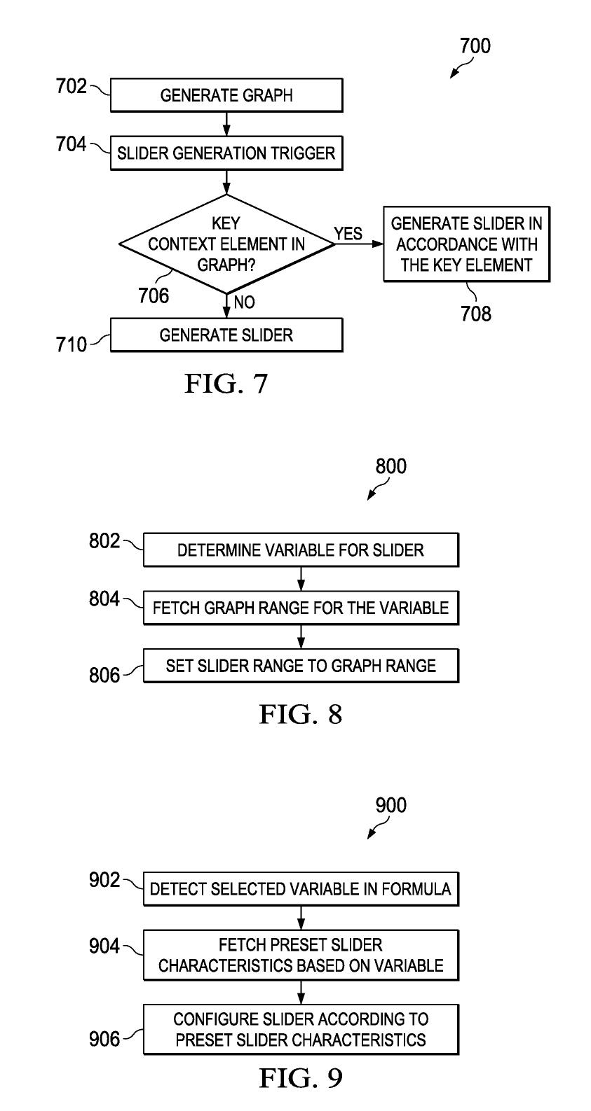

FIG. 7 is a flow diagram of an example method. Method 700 begins with step 702 which generates a graph on the display of a graphing device, such as graph 402 (FIG. 4), graph 502 (FIG. 5) or graph 602 (FIG. 6). Step 704 includes a trigger for generation of a slider on the graph. The trigger may be from user input, such as a menu command, or automatic generation from an entered equation. Step 706 determines if the graph contains a key context element, such as a range from a minimum 416 to a maximum 420 (FIG. 4) or a recognized variable, such as η (FIG. 6). If a key context element is present in the graph, step 708 generates a slider in accordance with the key context element. If multiple key context elements are present, step 708 generates the slider in accordance with key context element with a highest priority. Alternatively, step 708 may generate multiple sliders in accordance with the multiple key context elements in the graph. If the graph does not include key context elements, step 710 generates the slider using default parameters or user-entered parameters.

FIG. 8 is a flow diagram detailing an example operation of step 708 (FIG. 7). Method 800 starts with step 802, which determines which of the graphed variables ties to the slider. Step 804 fetches the range of the graph for that variable. Step 806 sets the range of the slider in accordance with the range determined in step 806.

FIG. 9 is a flow diagram of another example operation of step 708 (FIG. 7). Step 708 (FIG. 7) may implement one or both methods of FIGS. 8 and 9. Implementation of both methods includes a step to determine if the slider is based on a graphed variable or a for a tied function. If the slider is based on a graphed variable, this step (not shown) may select method 800 (FIG. 8). If the slider is based on a variable in a tied function, this step (not shown) may select method 900. Step 902 detects if one of the predetermined variables is in the tied function. Step 904 fetches the slider characteristics tied to the variable detected in step 902. Step 906 configures the slider in accordance with the fetched slider characteristics.

As noted hereinabove, the examples of FIGS. 4-9 can be implemented in a graphing device. A graphing device includes devices with built-in functionality operable to perform the functions described regarding FIGS. 4-9. Such functionality may be implemented by, for example, storing instructions to execute the functionality of FIGS. 4-9 into a memory unit, such as memory unit 204 (FIG. 2), whether in RAM or ROM or nonvolatile memory such as FLASH or EEPROM. In another example, such functionality may be implemented by storing software instructions on a non-transitory medium that, when executed, perform the functionality described regarding FIGS. 4-9. Examples of non-transitory media include a portable drive storing software for loading onto a graphing calculator, tablet, personal computer or other computing device. In another example, the non-transitory medium may be a server operable to download software onto one or more of such devices. The software can be stored in a cloud computing system or accessed using a browser directed to a uniform resource locator (URL) for locating the software over the internet.

Modifications are possible in the described arrangements and other arrangements are possible, within the scope of the claims.

What is claimed is:

1. A graphing device comprising:
a display; and
a processor in communication with the display, the processor operable to present a graph of a function on the display and operable to generate a slider on the display in which at least one parameter of the slider is derived from a context element of the graph.

2. The graphing device of claim 1 in which the context element is a range.

3. The graphing device of claim 2 in which the slider includes a pointer selecting a value within the range.

4. The graphing device of claim 1 in which the context element is a variable.

5. The graphing device of claim 4 in which a pointer of the slider selects a value of the variable.

6. The graphing device of claim 4 in which increments of the slider are in accordance with the variable.

7. The graphing device of claim 1 in which the graphing device is a graphing calculator.

8. A method, comprising:
generating a graph on a display of a graphing device; and
generating a slider on the display of the graphing device in which at least one parameter of the slider is derived from a context element of the graph.

9. The method of claim 8 in which the context element is a range.

10. The method of claim 9 in which the slider includes a pointer selecting a value within the range.

11. The method of claim 8 in which the context element is a variable.

12. The method of claim 11 in which a pointer of the slider selects a value of the variable.

13. The method of claim 11 in which increments of the slider are in accordance with the variable.

14. The method of claim 8 in which the graphing device is a graphing calculator.

15. A non-transitory medium storing software instructions that, when executed, perform a method comprising:
generating a graph on a display of a graphing device; and
generating a slider on the display of the graphing device in which at least one parameter of the slider is derived from a context element of the graph.

16. The non-transitory medium storing software instructions that, when executed, perform the method of claim 15 in which the context element is a range.

17. The non-transitory medium storing software instructions that, when executed, perform the method of claim 16 in which the slider includes a pointer selecting a value within the range.

18. The non-transitory medium storing software instructions that, when executed, perform the method of claim 15 in which the context element is a variable.

19. The non-transitory medium storing software instructions that, when executed, perform the method of claim 18 in which a pointer of the slider selects a value of the variable and increments of the slider are in accordance with the variable.

20. The non-transitory medium storing software instructions that, when executed, perform the method of claim 15 in which the graphing device is a graphing calculator.
